(19) United States
(12) Patent Application Publication
(10) Pub. No.: US 2014/0349843 A1
(43) Pub. Date: Nov. 27, 2014

(54) Structured Cathode Catalysts for Fuel Cell Application Derived From Metal-Nitrogen-Carbon Precursors, Using Hierarchically Structured Silica as a Sacrificial Support

(71) Applicant: STC.UNM, Albuquerque, NM (US)

(72) Inventors: Wendy Patterson, Albuquerque, NM (US); Michael Robson, Albuquerque, NM (US); Candace Walker, Albuquerque, NM (US); Alexey Serov, Albuquerque, NM (US); Barr Halevi, Albuquerque, NM (US); Kateryna Artyushkova, Albuquerque, NM (US); Plamen B. Atanassov, Santa Fe, NM (US)

(73) Assignee: STC.UNM, Albuquerque, NM (US)

(21) Appl. No.: 14/345,290

(22) PCT Filed: Sep. 17, 2012
(86) PCT No.: PCT/US2012/055774

§ 371 Date: Mar. 17, 2014

Related U.S. Application Data
(60) Provisional application No. 61/535,406, filed on Sep. 16, 2011.

(51) Int. Cl. H01M 4/90

(52) U.S. Cl. CPC H01M 4/9041; H01M 4/9016
USPC 502/182

(57) ABSTRACT

Methods for forming novel fuel cell catalysts are described. The catalyst has a physical structure that is the inverse image of a plurality of hierarchically structured sacrificial support particles. The particles may be formed independently and then infused with one or more transitional metallic salts and nitrogen carbon precursors, or the sacrificial support precursors, transitional metallic salts, and nitrogen carbon precursors may all be combined in such a way that a hierarchically structured sacrificial support with the infused transitional metallic salts and nitrogen carbon precursors is formed in a single step. The infused sacrificial support is then pyrolized, at least once, and the sacrificial support is removed, resulting in the catalyst.

### CROSS-REFERENCE TO RELATED APPLICATIONS

The following application claims benefit of U.S. Provisional Application No. 61/535,406, filed Sep. 16, 2011 which is hereby incorporated by reference in its entirety.

### BACKGROUND

Fuel cells are electrochemical devices that combine hydrogen and oxygen to produce electricity, water, and heat. Unlike batteries, fuel cells continuously generate electricity, as long as a source of fuel is supplied. Fuel cells do not burn fuel, making the process quiet, pollution-free and two to three times more efficient than combustion. Fuel cells therefore offer a highly efficient and fuel-flexible technology that cleanly produces power and heat with low or zero emissions. With a multitude of end-uses—such as distributed power for backup, primary, and combined heat-and-power systems; automobiles, buses, forklifts and other specialty vehicles; and auxiliary power units and portable electronics fuel cell applications hold potential to dramatically impact the 21st century clean energy economy.

There are a number of different types of fuel cells that rely on different types of fuel and different types of catalysts. Regardless of the type of fuel used, fuel cells include a cathode and an anode, separated by an electrolyte. As shown in FIG. 1, oxygen, from air, is reacted with electrons and reduced on the cathode via Oxygen Reduction Catalysts (ORRC). This reaction yields hydroxyls that diffuse across the electrolytic membrane to the anode side. The hydroxyls then react with and oxidize fuel using oxidation catalysts on the anode, yielding water and electrons, which are then used as a source of power. While the theoretical performance is determined by the fuels, the actual performance is usually determined by how well the catalysts perform. Accordingly, a major focus in fuel cell development is the optimization of catalysts, catalytic materials, and methods for producing them.

It should be noted that while the anode side oxidation catalysts are specific to the type of fuel being used in the fuel cell, the cathode side oxygen-reduction catalysts are required by all fuel cells are need not be fuel-specific. Accordingly, optimization of OORCs is beneficial to all fuel cells.

Most state of the art fuel cells rely on platinum-based catalysts. Unfortunately platinum is a very expensive metal, costing approximately $60/gr in 2011, significantly increasing the overall costs of fuel cells and making them impractical for a number of technologies and uses. Recent research has focused on the development of non-platinum group catalysts (non-PGMCs), but these are often made from expensive chemical precursors, limiting their advantages over platinum-containing catalysts. Furthermore, those non-PGMCs that have been developed typically suffer from a number of problems that limit their practical usage including low kinetic activity, low stability in acidic environments, and low durability in acidic and alkaline environments.

In order to address these issues, non-PGMCs are typically supported on relatively high surface area carbon materials or carbon blacks. However, these carbon materials do not allow for the control of structural features and thus cannot take advantage of the benefits that can be obtained from specific structures.

Due to the significant environmental advantages presented by fuel cell technology, there is an urgent and compelling need for low cost, kinetically active, stable and durable, catalysts and methods for making the same.

### BRIEF DESCRIPTION OF THE DRAWINGS

FIG. 1 is a schematic illustration showing the general mechanism for a typical fuel cell.

FIG. 2 is a schematic illustration showing a general method for forming a catalyst, according to an embodiment of the present disclosure, by infusing a transition metal salt and N—C precursor into a hierarchically structured porous particle.

FIG. 3 is an SEM image of a hierarchically structured silica particle (HSSP).

FIG. 4 is an SEM image of an HSSP with loaded metal-nitrogen-carbon precursor.

FIG. 5 is an SEM image of a catalyst formed from the HSSP of FIG. 4 after silica etching.

FIG. 6 provides the structural formula of various different salcomine-like precursors that are suitable for use in the presently described methods.

FIG. 7 is an STEM image for a catalyst derived from salcomine and sucrose precursors.

FIG. 8 presents RDE data for various salcomine-like catalysts in 1 M KOH saturated with O₂ (loading 400 ug cm⁻², 1600 RPM.)

FIG. 9 presents RDE data for salcomine catalysts with additional nitrogen precursor supplementation and heat treatment. The experiment was performed in 1 M KOH saturated with O₂ (loading 400 ug cm⁻², 1600 RPM.)

FIG. 10 presents RDE data for salcomine catalysts, with and without addition of urea as a source of additional nitrogen. Experiments were performed in 1 M KOH saturated with O₂ (loading 400 ug cm⁻², 1600 RPM.)

FIG. 11 presents RDE data for Fe-phthalocyanine and sucrose based catalysts tested in alkaline media saturated with O₂ (loading 400 ug cm⁻², 1600 RPM.)

FIG. 12 presents RDE data for Fe-phthalocyanine and sucrose based catalysts tested in neutral media saturated with O₂ (loading 400 ug cm⁻², 1600 RPM.)

FIG. 13 presents RDE data for Fe-phthalocyanine and sucrose based catalysts tested in acid media saturated with O₂ (loading 400 ug cm⁻², 1600 RPM.)

FIG. 14 is a TEM images of Fe-phthalocyanine catalyst prepared on HSSP.

FIG. 15 is a close-up TEM images of Fe-phthalocyanine catalyst prepared on HSSP.

FIG. 16 is a rotating disc electrode electro-voltammogram illustrating oxygen reduction for an Fe-Cyanamide based catalyst tested in 1M KOH saturated with O2 (loading 50 μg cm⁻², 1600 RPM, 50 mV s⁻¹).

FIG. 17 is a rotating disc electrode electro-voltammogram illustrating oxygen reduction for an Fe-Phenanthroline based catalyst tested in 1M KOH saturated with O2 (loading 50 μg cm⁻², variable RPM, 50 mV s⁻¹).

FIG. 18 is a TEM image of approximately ¼ of a ˜1 nm diameter catalyst particle.

FIG. 19 is a STEM image of a catalyst particle of the present disclosure.

FIG. 20 is an image showing individual elemental EDS mapping for N, Fe, O and C.

FIG. 21 is a cross-elemental EDS map of catalyst sample J621 showing C, N, and Fe.

FIG. 22 is a cross-elemental EDS map of catalyst sample J621 showing C, N, O, and Si.

FIG. 23 is a cross-elemental EDS map of catalyst sample J621 showing C, O, and Fe.

FIG. 24 is a cross-elemental EDS map of catalyst sample J621 showing C, Fe, and Si.

FIG. 25 is XPS high resolution spectra for catalyst sample J621.

FIG. 26 is XPS high resolution spectra for catalyst sample J517A.

FIG. 27 is a table showing the results of the analysis of species found in catalyst samples J621 and J517 with the shaded boxes highlighting the primary differences between the two samples.

FIG. 28 is EELS spectra for catalyst sample J621. The TEM image on the left corresponds to an iron particle in the carbon matrix.

FIG. 29 is a table showing a summary of the conditions used during RRDE measurement of selected catalysts.

FIG. 30 shows the results of RRDE experiments for selected catalysts in acidic environments.

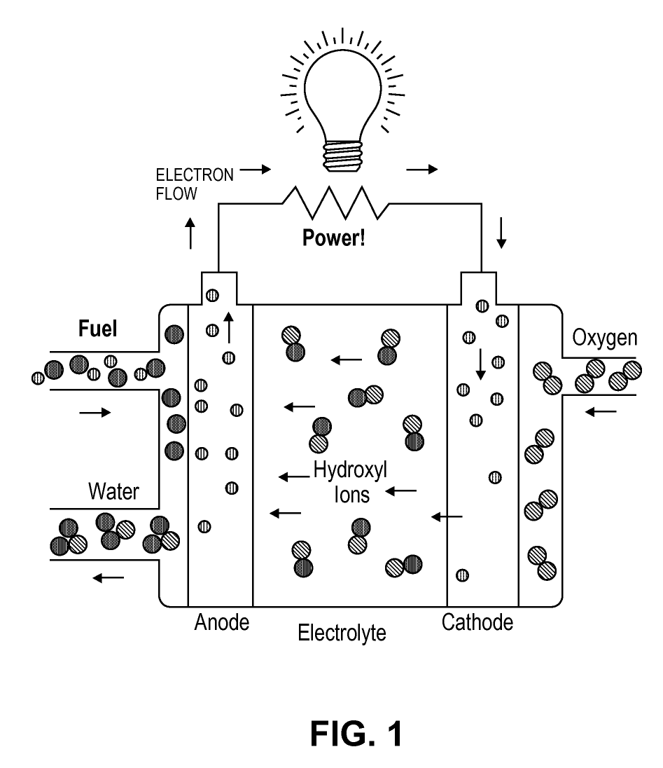

### DETAILED DESCRIPTION

According to an embodiment, the present disclosure provides a method for producing inexpensive non-platinum based catalysts (non-PGMC) that have significantly improved kinetic activity in oxygen reduction reactions over previously described non-PGMCs and which are both stable and durable. The method provides a single step template-based synthesis method that relies on the utilization of porous sacrificial structures to produce a carbon-supported catalyst having a controllable and highly complex three-dimensional structure. This three-dimensional structure addresses the inherent lower kinetic activity of the non-PGMC materials by increasing both gas transport and proton accessibility in the catalyst layer of the fuel cell.

For the sake of clarity, in the present application the term “catalyst” is used to refer to a final product, suitable for use, for example, in a fuel cell, which has catalytic activity. The catalyst may include multiple types of materials, some of which may not in themselves have catalytic activity (for example, supporting material.) The term “catalytic material” is any material which has catalytic activity either on its own or as part of a catalyst.

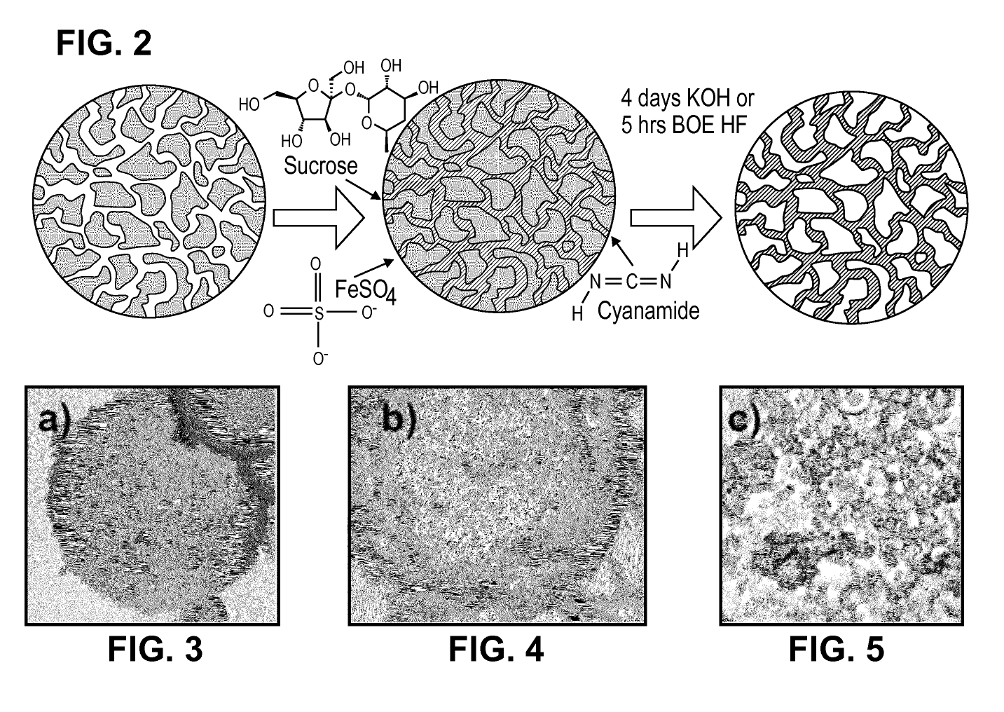

Turning now to FIGS. 2-5 collectively, according to a first embodiment, porous sacrificial particles are infused with one or more transition metal salts and one or more nitrogen-carbon (N—C) precursors. An SEM image of an exemplary sacrificial support having hierarchical porosity, as described in greater detail below, is shown in FIG. 3.

Examples of suitable transition metals include, but are not necessarily limited to: Fe, Ce, Cr, Cu Mo, Ni, Ru, Ta, Ti, V, W, and Zr. Exemplary transition metal salts include, but are not necessarily limited to: nitrates, chlorides, acetates, sulfates, carbonyls etc.

In general, nitrogen-carbon precursors are organic molecules that either have low molecular weight or are polymeric. They can be aliphatic, cyclic or aromatic. Furthermore, the nitrogen can be incorporated in an aromatic ring, aliphatic chain or in a cyclic compound. N—C compound can also include other hetero-atoms, like O, S, B, Se, etc.

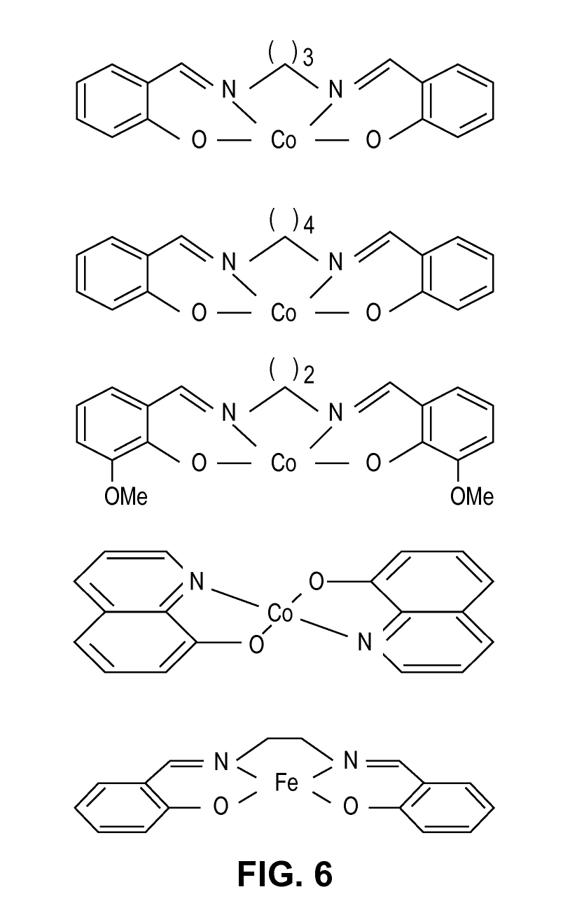

According to one embodiment, salcomine and salcomine-like precursors are used. Salcomine, bis(salicylidene)ethylene diamino-cobalt (II), and its Fe containing analogs are examples of precursors that contain Co and/or Fe as transition metals, where the nitrogen and oxygen are provided through a combined ligand that coordinates the transition metal to both. These precursors contain a structural motif in which the transition metal, Co or Fe, is coordinated by two nitrogen and two oxygen atoms of the ligand. Accordingly, these precursors enable the designed catalyst to combine functionalities of N and O containing active sites. This allows for active site design in which the two active sites are in immediate proximity to maximize the 2×2 electron transfer, ORR mechanism. FIG. 6 provides the structural formula of various different salcomine-like precursors that are suitable for use in the presently described methods.

Examples of other suitable N—C precursors include, but are not limited to: Polyethyleneamine; ethylenediamine branched; 4-Aminoantipyrine; 1,2-Phenyanthroline; Phenanthroline; Poly(2-ethyl-2-oxazoline); Poly(4-vinylpyridine); Poly(acrylamide-co-diallyldimethylammonium chloride) solution; Poly(melamine-co-formaldehyde) methylated, solution; Poly(pyromellitic dianhydride-co-4,4?-oxydianiline), amic acid solution; Poly(dimethylamine-co-epichlorohydrin-co-ethylenediamine) solution; Poly(1-vinylpyrrolidone-co-2-dimethylaminoethyl methacrylate) solution; Poly(1-vinylpyrrolidone-co-2-dimethylaminoethyl methacrylate) solution; Poly[[6-[(1,1,3,3-tetramethylbutyl)amino]-s-triazine-2,4-diyl]-[(2,2,6,6-tetramethyl-4-piperidyl)imino]-hexamethylene-[(2,2,6,6-tetramethyl-4-piperidyl)imino]; 4-(Aminomethyl)pyridine; 2-Amino-4-picoline; Aminophylline; 2-Amino-6-methylpyridine 98%; 2-Amino-3-picoline; piperazine; Pyrimidyl; imidazole; indole; pyrazole; piperidine; Pyrrolidinyl; pyrrolidine; 4,4?-Oxydianiline;)1-(2-Aminoethyl)piperazine; Aminophylline; 1,2,4-Triazole; 3,5-Diamino-1,2,4-triazole; Phenazinemelamine; urea etc. For the purposes of the present disclosure, the precursors described in this paragraph, as well as their analogs, will be referred to collectively as non-salcomine precursors.

According to some embodiments, the sacrificial supports are synthesized and infused in a single synthesis method, as demonstrated in Example 1, below. According to other embodiments, the sacrificial supports are synthesized first and then infused with the transition metals salts and nitrogen-carbon precursors, as demonstrated in Example 2, below.

The infused particles are then subjected to heat treatment, such as pyrolysis) in an inert (N2, Ar, He, etc.) or reactive (NH3, acetonitrile, etc.) atmosphere. FIG. 4 is an SEM image of a sacrificial support infused with precursor materials after heat treatment. Inert atmospheres are typically used when the C—N precursor is nitrogen rich, as the inert atmosphere enables the production of a high number of active sites with Fe (or other metal) N4 centers. However, it may be desired to use a reactive, nitrogen rich atmosphere if the C—N precursor is rich in carbon and depleted in nitrogen, as the nitrogen rich atmosphere will enable production of the Fe (or other metal) N4 centers. According to an embodiment, optimal temperatures for heat treatment are between 500 and 1100° C. According to some embodiments, heat treatment between 800 and 900° C. is preferred, as this temperature is high enough to pyrolize the material, but is typically not high enough to destroy the active sites. According to some embodiments, it may be desirable to undergo multiple rounds of heat treatment in order to obtain a catalyst having the desired activity.

After heat treatment, the sacrificial particles are removed using suitable means. FIG. 5 is an SEM image of the resulting catalyst after the sacrificial support has been removed. The open-framed, carbon support decorated with metal, nitrogen and oxygen species is clearly visible in this image. According various embodiments, the sacrificial support may be removed via chemical etching. Examples of suitable etchants include NaOH, KOH, and HF. According to some embodiments, it may be preferable to use KOH, as it preserves all metal and metal oxide in the catalyst and, if the species are catalytically active, use of KOH may, in fact, increase catalytic activity. Alternatively, in some embodiments, HF may be preferred as it is very aggressive and can be used to remove some poisonous species from the surface of the catalyst. Accordingly, those of skill in the art will be able to select the desired etchants based on the particular requirements of the specific catalytic material being formed.

According to a still further embodiment, the resulting catalysts may be further processed to improve catalytic activity and/or stability, or for functionalization. Examples of post-processing steps include, but are not limited to an additional heat treatment step or etching and chemical degradation of the resulting structure using chemically active gasses including oxygen, air, ammonia, hydrogen; vapors such as water, acids, and bases; and liquids such as water, acids, and base. An additional heat treatment step may improve catalytic activity. Chemical etching and degradation improves durability and stability and also allows for chemical functionalization, including surface functionalization, of the catalyst with, for example, amino groups. According to an embodiment, functionalization can be achieved by grafting those groups onto the surface of catalysts by known methods such as polymerization or electrochemical deposition.

The above-described methods produce open-framed structures of synthetic carbon supports decorated with the nano-phase metallic catalytic material of choice and having the inverse morphological features of the original porous sacrificial particles. Accordingly, it will be appreciated that the structure of the catalyst is determined by the (inverse) structure of the porous sacrificial particles. Thus, one can precisely select and control the structural morphology of the resultant catalyst by choosing and/or designing the structure of the sacrificial particles.

It should be appreciated that the porous sacrificial particles can be formed from any suitable material which will enable infusion of the selected transitional metal salt(s) and N—C precursors and which can be removed without significant damage to the resulting catalyst. Suitable materials for the particles include, but are not limited to silica, alumina, magnesia, zeolites, barium oxide, strontium oxide, etc. Furthermore, it will be understood that the porous sacrificial particles may be of any desired physical shape including, irregularly or regularly shaped, spheres, ovoids, cylinders, cones, cubes, cuboids, pyramids, prisms, etc. Furthermore, the population of particles used to form a catalyst may be monodisperse or comprise differently-sized particles. Furthermore, the population of sacrificial particles may include particles that differ in other ways including, but not limited to different shapes, materials, and/or internal or external structures.

It will also be appreciated that while the disclosure typically refers to the sacrificial particles as being porous, certain embodiments are contemplated wherein the particles might be solid rather than porous. Furthermore, the present disclosure also contemplates embodiments where the internal structure of the particle might not be considered “porous,” but instead includes an open framework of some type.

According to one specific embodiment, the sacrificial support particles may have hierarchical porosity meaning that they have at least a bi-modal distribution of pore sizes within their internal pore structure. Examples of particles having hierarchical porosity and method for forming them are described, for example, in U.S. patent application Ser. No. 12/484,855, filed Jun. 15, 2009 and Ser. No. 13/161,302, filed Jun. 15, 2011, each of which are hereby incorporated by reference. Briefly, in the '855 application, an aqueous sol phase containing a metal oxide precursor and an ionic surfactant are emulsified to form large droplets containing both microemulsion oil droplets and micelles. The droplets are then allowed to polymerize and are then pyrolyzed to form microparticles containing both mesopores, which form due to the presence of the microemulsion oil droplets, and nanopores, which form due to the presence of the micelles. The '302 application discloses a microfluidics-based method for producing particles having a bimodal pore distribution. Both systems produce particles appropriate for use in the presently described method. The microfluidics-based approach has the advantage of allowing the user to carefully control the size of the particles being produced and to producing a monodisperse population of particles, which may or may not be desired in the presently-described method.

The specific methods and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. The methods and processes illustratively described herein suitably may be practiced in differing orders of steps, and that they are not necessarily restricted to the orders of steps indicated herein or in the claims. As used herein and in the appended claims, the singular forms “a,” “an,” and “the” include plural reference unless the context clearly dictates otherwise. Thus, for example, a reference to “particle” includes a plurality of such particles.

Under no circumstances may the patent be interpreted to be limited to the specific examples or embodiments or methods specifically disclosed herein. Under no circumstances may the patent be interpreted to be limited by any statement made by any Examiner or any other official or employee of the Patent and Trademark Office unless such statement is specifically and without qualification or reservation expressly adopted in a responsive writing by Applicants.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

All patents and publications referenced below and/or mentioned herein are indicative of the levels of skill of those skilled in the art to which the invention pertains, and each such referenced patent or publication is hereby incorporated by reference to the same extent as if it had been incorporated by reference in its entirety individually or set forth herein in its entirety. Applicants reserve the right to physically incorporate into this specification any and all materials and information from any such cited patents or publications.
Gasteiger, H., Kocha, S., Sompalli, B., Wagner, F., Activity benchmarks and requirements for Pt, Pt-alloy, and non-Pt oxygen reduction catalysts for PEMFCs. Applied Catalysis B: Environmental 2005. 56: p. 9-35.
Breakthrough Technologies Institute, I., 2010 Fuel Cell Technologies Market Report. 2010.
Carroll, Nick J., Svitlana Pylypenko, Plamen B. Atanassov, and Dimiter N. Petsev. “Microparticles with Bimodal Nanoporosity Derived by Microemulsion.” Langmuir. 25.23 (2009): 13540-44. Print.
Pylypenko, Svitlana, Tim S. Olson, Nick J. Carroll, Dimiter N. Petsev, and Plamen Atanassov. “Templated Platinum/Carbon Oxygen Reduction Fuel Cell Electrocatalysts.” Journal of Physical Chemistry C. 114.9 (2010): 4200-07. Print.
Jaouen, Frederic, J. Herranz, M. Lefevre, J. P. Dodelet, U. I. Kramm, I. Herrmann, P. Bogdanoff, J. Maruyama, T. Nagaoka, A. Garsuch, J. R. Dahn, T. Olson, S. Pylypenko, P. Atanassov, and E. A. Ustinov. “Cross-Laboratory Experimental Study of Non-Noble-Metal Electrocatalysts for the Oxygen Reduction Reaction.” Applied Materials & Interfaces. 1.8 (2009): 1623-39. Print. F. Jaouen, Appl. Mater. Interfaces, (2009)
Wu, Gang, Karren L. More, Christina M. Johnston, and Piotr Zelenay. “High-Performance Electrocatalysts for Oxygen Reduction Derived from Polyaniline, Iron, and Cobalt.” SCIENCE. 332.6028 (2011): 443-47. Print.

### EXAMPLES

### Example 1

### Salcomine-Derived Catalysts—One Pot Synthesis

Catalysts were prepared using precursors of the salcomine family and their iron-containing analogs (see FIG. 6) by dissolving 1.82 g of CTAB in a desired amount water for 15-30 min. HCl+TEOS is then added to the Sol and dissolved 10 min Cobalt nitrate and salcomine are then added and the solution is allowed to sit for 1 hour. 5 mL of the Sol is then mixed with 15 mL 3 wt % hexadecane phase. The resulting solution is emulsified and transferred to a 1000 mL round bottom flask. The flask is heated in an oil bath to 80° C., and then placed under vacuum for 1 hour. The resulting particles are then centrifuged and then heat treated in N₂ at 800° C. for 5 hours.

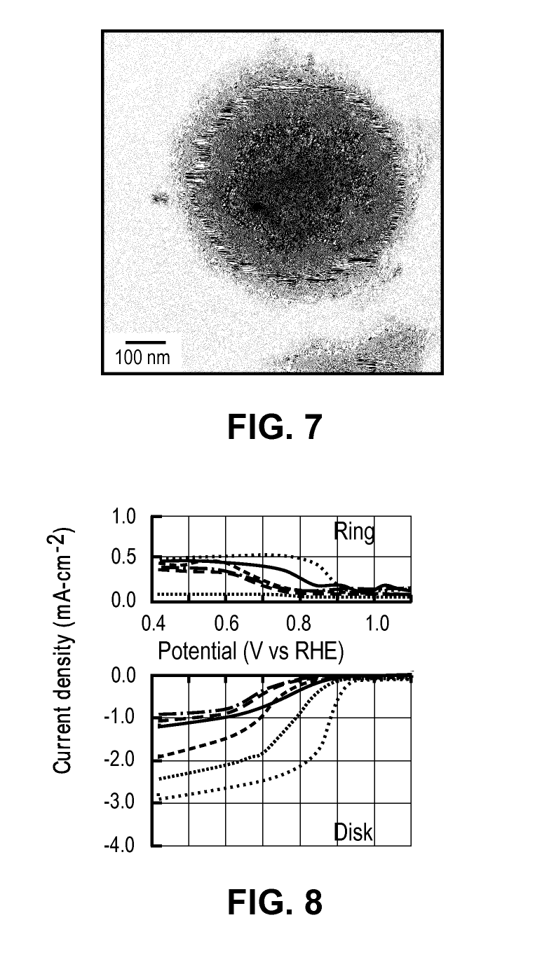

FIG. 7 is an STEM image for a catalyst derived from salcomine and sucrose precursors. These results show that the presently-described method results in open, framed, highly porous, carbon-based structures. High resolution STEM images show ˜6 nm pore paths, which were determined to contain a mixture of primarily cobalt, cobalt oxide and carbonaceous species. The bulk of the remainder of the material consists of carbon with traces of cobalt, oxygen, and nitrogen as determined by EDS (now shown.)

FIG. 8 presents RDE data for various salcomine-like catalysts in 1 M KOH saturated with O₂ (loading 400 ug cm⁻², 1600 RPM.) As shown, the salcomine family ligand was varied from the standard salcomine molecule in order to investigate the effect of active site “engineering”.

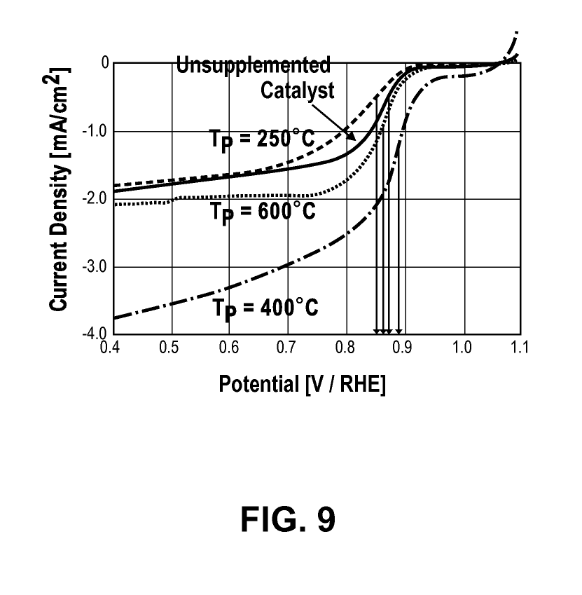

FIG. 9 presents RDE data for salcomine catalysts with additional nitrogen precursor supplementation and heat treatment. The experiment was performed in 1 M KOH saturated with O₂ (loading 400 ug cm⁻², 1600 RPM.)

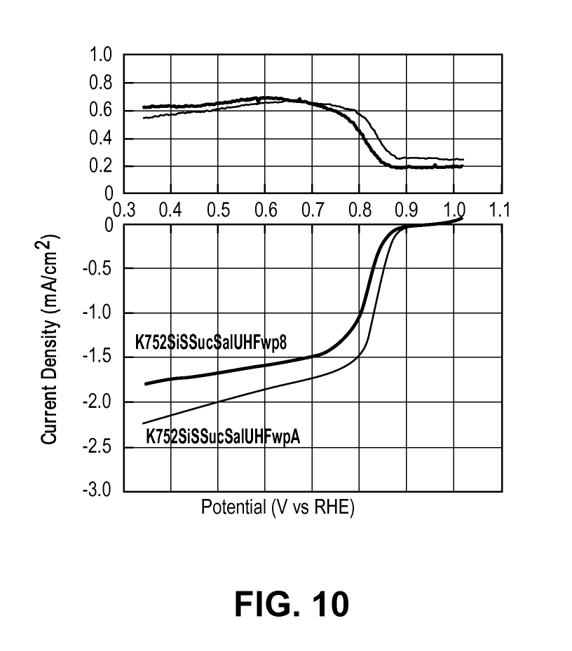

FIG. 10 presents RDE data for salcomine catalysts, with and without addition of urea as a source of additional nitrogen. Experiments were performed in 1 M KOH saturated with O₂ (loading 400 ug cm⁻², 1600 RPM.)

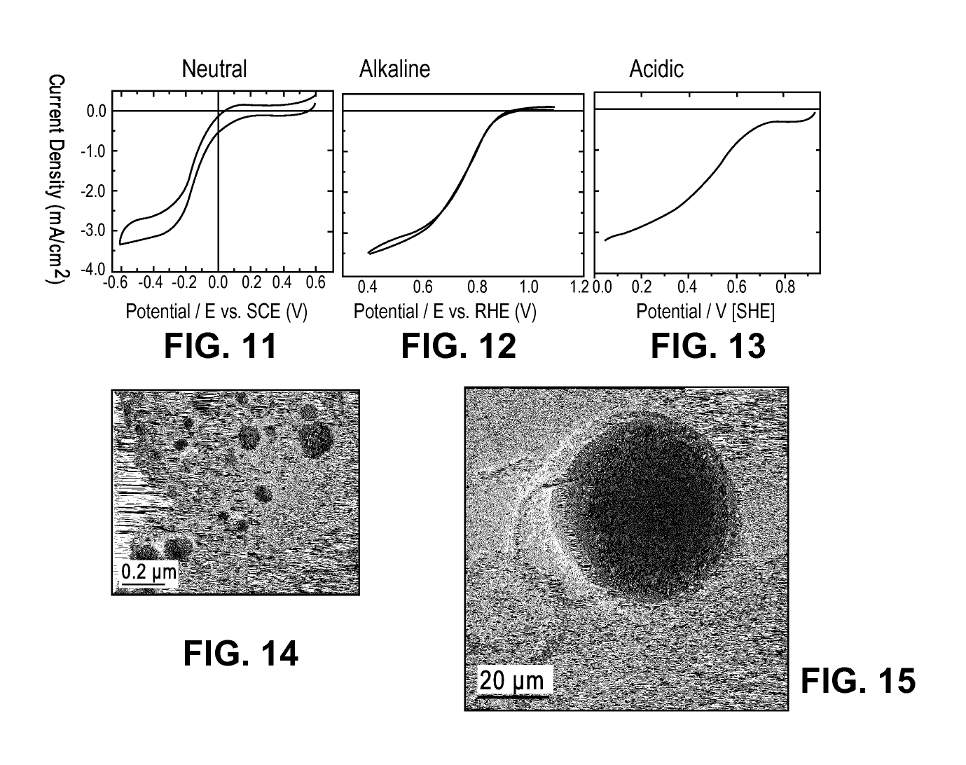

FIGS. 11-13 present RDE data for Fe-phthalocyanine and sucrose based catalysts tested in alkaline (FIG. 11), neutral (FIG. 12), and acid (FIG. 13) medias saturated with O₂ (loading 400 ug cm⁻², 1600 RPM.)

FIGS. 14-15 are TEM images of Fe-phthalocyanine catalysts prepared on HSSP.

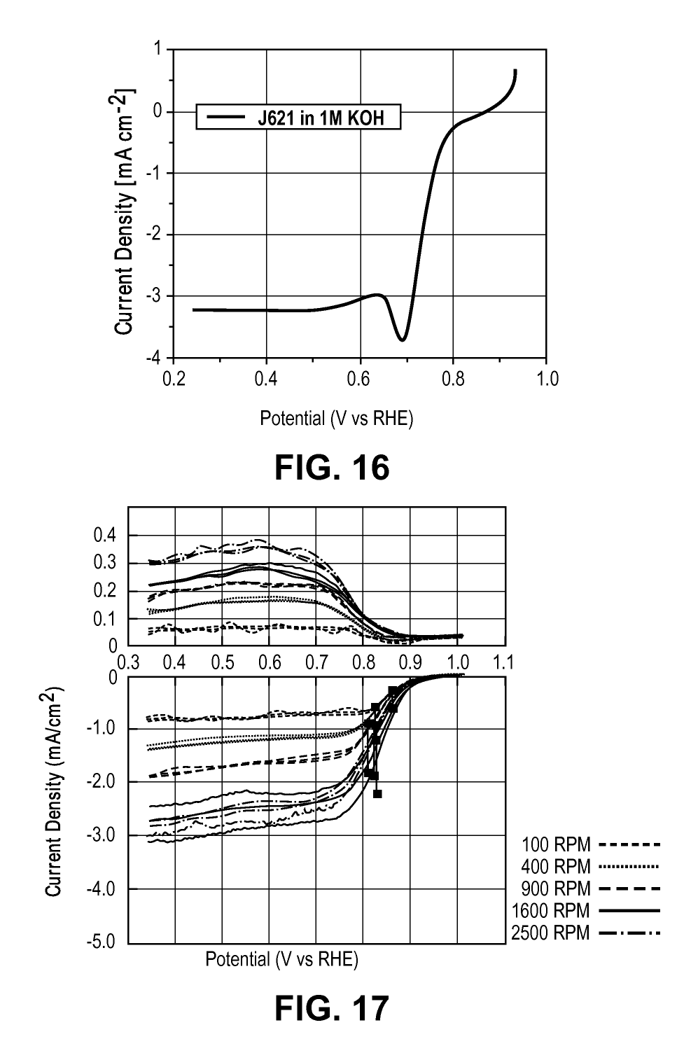

FIG. 16 is a rotating disc electrode electro-voltammogram illustrating oxygen reduction for an Fe-Cyanamide based catalyst tested in 1M KOH saturated with O2 (loading 50 ng cm⁻², 1600 RPM, 50 mV s⁻¹).

FIG. 17 is a rotating disc electrode electro-voltammogram illustrating oxygen reduction for an Fe-Phenanthroline based catalyst tested in 1M KOH saturated with O2 (loading 50 ng cm⁻², variable RPM, 50 mV s⁻¹).

### Example II

### Catalyst Synthesis Using Non-Salcomine Precursors

A series of samples were prepared from similar precursors to explore how various synthesis routes can lead to electrocatalysts with vastly different structural and performance properties. The focus was primarily on the combination of FeSO4, Cyanamide, and sucrose precursors in various ratios, templated with a lost wax technique using HSS. The Cyanamide provides a source of nitrogen while the sucrose increases the carbon content of the catalyst, which provides a higher electrical conductivity in the final product.

### 1. Materials and Methods

Table 1 below gives a very brief summary of materials synthesized for this study.

Table 1 Summary of selected samples, with precursor particitions in weight %.

| Sample | Template | Metal | Nitrogen | Carbon | Pyrolysis Conditions |
|---|---|---|---|---|---|
| J517A | HSS (15%) | FeSO₄ (23%) | Cyanamide (46%) | Sucrose (16%) | 10°/min, 900° C., 6 hrs |
| J517B | HSS (15%) | FeSO₄* (23%) | Cyanamide (46%) | Sucrose (15%) | 10°/min, 900° C., 6 hrs |
| J621 | HSS (16.2%) | FeSO₄ | Cyanamide | From Cyan. Only | 2X: 30°/min/950° C., 1 hr |
| | | (25.3%) | (58.6%) | | |

It is noted that in sample J517B, the metal was added after a first round of pyrolysis and then re-pyrolyzed under the same conditions. All samples were etched with HF acid, and pyrolyzed in UHP N₂.

1.1 Synthesis of Mesoporous Silica

The HSS was synthesized using a microemulsion templating method as further described in Carroll et al., Langmuir. 25.23 (2009): 13540-44, incorporated by reference above. The silica precursor was first prepared, where 1.82 g of cetyltrimethylammonium bromide (CTAB), from Sigma-Aldrich, is dissolved in 20 g of diH2O heated to 40° C., and stirred vigorously. Then, 5.2 g of tetraethylorthosilicate (TEOS, Purum >98%, from Fischer Scientific), was added with 2.85 g of 1 M hydrochloric acid (HCl) (J. T. Baker) to the solution and stirred at room temperature for 30 minutes. The final pH of the sol was determined to be ˜2.0. The HCl was increased from 0.57 g to 2.85 g, an increase of 5 times, as the additional HCl increases the surface pore size, allowing for easier fluid transport through the particles. Easier fluid transport through the particles also allows for quicker precursor impregnation and also assures that the entire particle is saturated with the catalyst precursors.

The oil phase was prepared by dissolving modified polyether-polysiloxane/dimethicone copolyol surfactant (ABIL EM 90, from Degussa), in hexadecane (3% wt, from Fischer Scientific). The aqueous phase was added to the oil phase, and the vial was shaken vigorously for approximately 5 minutes in order to emulsify the resulting solution. After the addition of the aqueous phase to the oil phase, the solution was transferred to an evaporation flask, placed in a rotary evaporator, and heated to 80° C. under reduced pressure (70 mTorr) for approximately 40 minutes. The solution was cooled, centrifuged, and the supernatant decanted. A calcination period followed whereby the particles were heated to 500° C. for 5 hours in air.

1.2 Liquid Precursor Synthesis

The sucrose, Cyanamide and iron (II) sulfate heptahydrate salts were acquired from Sigma-Aldrich. The acetone, absolute ethanol, and acetonitrile were purchased from Ultra Pure Solutions, Inc. Sulfuric acid and sucrose were produced by EMD. All materials were used as received from the manufacturer, with the exception of the acid, which was diluted from 17.8 M to 1 M. The precursor solutions were made by combining cyanamide, FeSO₄.7H₂O, and for catalysts calling for the addition of a carbon source, sucrose. To dissolve the solids, 1 mL H₂SO₄ was added followed by 2.6 mL of an appropriate solvent, typically acetone, acetonitrile or ethanol. The solutions were then sonicated using a probe sonicator set on amplitude 2.0 for 2 minutes, or until the solution is homogenous and all precursors are dissolved. If necessary, more H₂SO₄ is added to maintain the suspension.

1.3 Dry Impregnation of Silica

Infusion of the precursor molecules into the HSS is the most arduous, and arguably the most important, part of synthesis. One infusion route explored was a dry impregnation process where a step-wise addition of the precursor solution was added to the dried silica in a ceramic crucible, or similar vessel. The solution was pipetted onto the silica in aliquots of 100 μL, followed by stirring for several minutes to allow for even distribution throughout the silica. Waiting a minimum of 30 minutes between infusions, this process was repeated until all of the solution had been added to the silica. The shape and size of the vessel are important for this process as the solvent must be able to evaporate, but not until sufficiently infused into the network of pores of the HSS.

Given the nature of our synthesis process, we have the flexibility of adding precursors either all at once, or in a desired sequence. This was briefly explored for two materials with the addition of Fe precursor. For sample J517B, the iron precursor was added after pyrolyzation of the templated cyanamide/sucrose, in order to avoid over treating the Fe and to allow for a decorated phase of metal, versus an internally deposited phase.

1.4 Wet Impregnation

As an alternative to the dry impregnation described in Section 2.3, the following procedure was implemented for sample J621 only. The synthesis began by saturating 25 mL of reagent alcohol (90% EtOH, 5% MeOH, 5% isopropyl alcohol) with nitrogen gas for 5 minutes. Next, 0.1493 g of FeSO₄.H₂O and 0.3455 g Cyanamide were dissolved in the reagent alcohol and mixed in N₂ for 5 minutes until dissolved. Next, a round bottom flask was preheated to 65° C. and the solution was refluxed and stirred for 1 hour under N₂ flow. Then 0.0952 g of HSS was added to the flask. This mixture was refluxed for 20 hours, under N₂ flow. The reagent alcohol was then evaporated under N₂. The residue was scraped from the flask and ground with a mortar and pestle.

1.5 Pyrolyzation and Post-Treatment

Thermogravametric analysis (TGA) yields critical information regarding transition temperature allowing for selection of ideal pyrolysis conditions for the catalysts. Variations in the pyrolyzation process include multiple pyrolyzations, step pyrolyzation temperatures, final pyrolyzation temperature, and duration. The pyrolyzation process is a critical step in the synthesis process, for without it the sample will not calcine and active sites will not be established. It is hypothesized that all of these variables are factors in the stabilization of the catalyst and/or the catalytic activity. For Fe-based catalysts, pyrolyzation conditions are typically around 900° C. with a fast ramp rate of >10° C./min.

For all materials, the original HSS template was removed by etching with a buffered HF solution for 24 hours, followed by a series of washing and centrifuge steps to remove the acid and residue.

In the case of sample J621 only, the powder then underwent an acid treatment in 20 mL of 0.5 M H₂SO₄ for 12 hours at 80° C. under reflux. The acid was rinsed by dilution with water and the sample was centrifuged several times until the supernatant was no longer acidic. Once completely dry, the material was ground to a fine powder and underwent a second pyrolysis under the same conditions as the first. It was hypothesized that this acid treatment would dissolve any undesired metal oxide species not incorporated into the template.

### 2. Characterization

Various methods were used to characterize the resulting Fe/Cyanamide catalysts. Such methods include, but are not limited to, TGA, SEM, TEM/STEM, EDS, XPS, BET, and RRDE.

2.1 Imaging: SEM, TEM, STEM

For imaging of the HSS template and the final catalyst structures, transmission electron microscopy (TEM) was conducted on a JEOL 2010 instrument, and scanning electron microscopy (SEM) was performed on a Hitachi S-800 instrument. High resolution, aberration corrected TEM and STEM images were acquired at Oak Ridge National Laboratory on a JOEL 2200FS microscope for sample J621 and are reported herein.

2.2 Surface Area and Pore Size Distribution

Detailed physisorption was performed at 77.4 K on a Quantachrome Autosorb-1 machine to characterize the pore volume and surface area of the HSS materials. Isotherms were analyzed to determine surface area and the pore size distribution. Prior to analysis, the sample was outgassed for 24 hours at 120° C. The adsorption data were analyzed using an NLDFT approach and a cylindrical pore model was assumed. Several of the final catalyst materials were also analyzed using a Micromeritics Gemini nitrogen adsorption system, where BET analysis was performed over the linear range of relative pressures.

2.3 Spectroscopy: XPS, EELS and EDS

In order to identify the chemical species present, both energy-dispersive X-ray spectroscopy (EDS) and X-ray photoelectron spectroscopy (XPS) studies were conducted. XPS analysis was performed on a Kratos AXIS Ultra photoelectron spectrometer operating at 300 W, with charge compensation using low energy electrons. The operating pressure was approximately 2×10−9 Torr. A thorough analysis of the composition and structure of pyrolyzed Fe/Cyanamide compounds was performed using a monochromatic Al Kα source and high-resolution XPS spectra were acquired. Survey and high resolution spectra were acquired at pass energies of 80 eV and 20 eV, respectively. High resolution spectra were recorded for the C 1s, N 1s, O 1s and Fe 2p core levels. A linear background subtraction was used for quantification of C 1s, O 1s and N 1s, while a Shirley background was applied to the Fe 2p spectra. All the spectra were charge-referenced to a gold reference source. The width of the peaks in the curve-fit of C 1s, N 1s, O 1s and Fe 2p were set to 1.0, 1.0, 1.3 and 1.4, respectively. An atomic percent obtained from curve fits of high resolution spectra of each element also accounts for elemental concentration. Additionally, electron energy loss spectroscopy (EELS) was conducted on a JEOL 2010 instrument for sample J621 only in order to determine the graphitic content of the catalyst.

2.4 Rotating Ring Disk Electrode Experiment

Electrochemical analysis was performed for all samples synthesized in Table 1 using the Pine Instrument Company electrochemical analysis system, PineChem 2.8 software, AFCBP1 bipotentiostat, and MSRX speed control module and rotor. The electrode was a glassy carbon disk electrode with a platinum ring. The catalyst inks were made using a known mass of catalyst with 30 μL of 0.5% sonicated Nafion/1 mg of catalyst, and the remaining volume a mix of 80/20 diH20/isopropyl alcohol (IPA). The final concentrations were typically 1 mg/mL, 4 mg/mL and 10 mg/mL, or as indicated below in the Results section. The catalysts were loaded onto the disk in either 10 μL or 20 μL aliquots, air dried, then re-wetted before testing. Rotational speeds used were 100, 400, 900, 1600 and 2500 RPM. The electrolyte was 0.1 M HClO₄ or 0.5 M H₂SO₄ saturated in O₂ at room temperature. A platinum wire counter electrode and a Ag/AgCl reference electrode were used. The standard conditions for the RRDE experiments were 10 μL of 10 mg/mL, rotated at 1600 RPM. The potential was varied between 1.0 V to −0.25 V with a sweep rate of 10 mV/s over 6 sweeps, with the cathodic sweep the initial direction.

### 3. Results and Discussion

The HSS template material has a Brunauer-Emmett-Teller (BET) surface area and pore volume greater than 1000 m2/g and ˜1 cc/g, respectively. Most of the surface area is attributed to the presence of the smaller 2-6 nm pores, formed by the CTAB micelles. These smaller pores are not visible in the SEM images but are detectable by nitrogen adsorption measurements and powder X-ray diffraction (XRD). The pore size analysis suggests the presence of larger (˜20-50 nm) and smaller (˜2-6 nm) pores. The cavities at the particle surfaces (observed by SEM) are larger than the pores in the interior of the particle. The catalysts have a BET surface area ranging from 300-950 m2/g, depending on the formulation.

As suggested by the SEM results, our initial open frame structures provide an adequate template whereby the catalysts retain the inverse morphology of the silica template. The high degree of cavitation resulting from the removal of the silica scaffolding gives the catalytically active sites more surface area whereby the oxygen can adsorb.

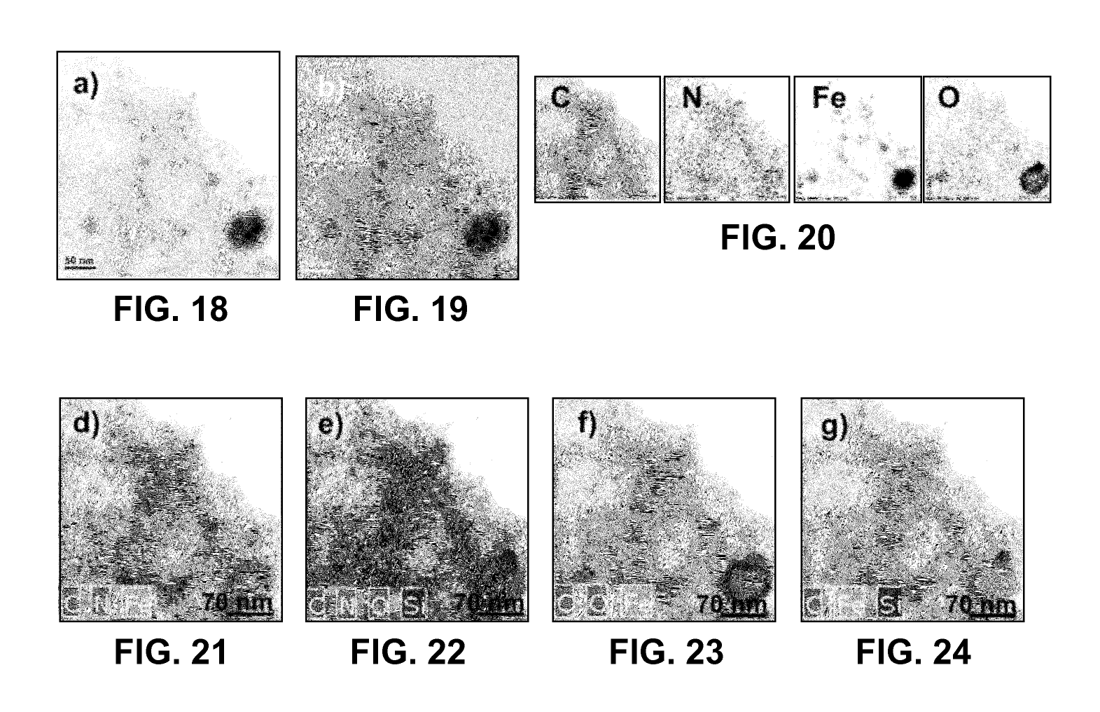

High resolution, aberration corrected TEM and STEM images were acquired at Oak Ridge National Laboratory on sample J621, and are shown in FIGS. 18-24. Of particular interest are several of the cross-element EDS mapping images (FIGS. 21-24) which provide insight into the composition of the catalyst. FIG. 18 is a TEM image of approximately ¼ of a ˜1 μm diameter catalyst particle. In combination with EDS, these images allow several conclusions to be made regarding the composition. It is clear from the EDS mapping data (FIG. 20) that the backbone of the catalyst is comprised of primarily carbon, as well as nitrogen. The nitrogen appears well dispersed and is likely underrepresented by our corroborating surface characterization methods such as XPS, which for this sample, gives a total nitrogen content of ˜2%. Another important conclusion drawn from these images is with respect to the Fe incorporation into the HSS template. The Fe can be classified into two categories: (1) that which does not get properly incorporated into the template structure, and (2) that which does properly infuse into the sacrificial silica template. Metal precursor not incorporated into the Si/C matrix grows into large particles outside of the catalyst, often forming an oxide layer (see FIGS. 20 and 23). From these figures we can further conclude that those particles outside the catalyst form either Fe—O or Fe—S complexes. If the precursor is properly incorporated, however, it appears that the template material provides a “protective housing”, not only limiting the growth of the metal particle to the diameter of the pores, but also preventing oxidization to a large degree. In general, the Fe found inside the catalyst is either elemental Fe or an Fe—S complex, which is logical given the metal precursor for this sample. Two additional elements that appear in our catalyst include Si (likely SiO₂, residual from the template material) and sulfur. The presence of these elements has not proven to be detrimental to our catalyst.

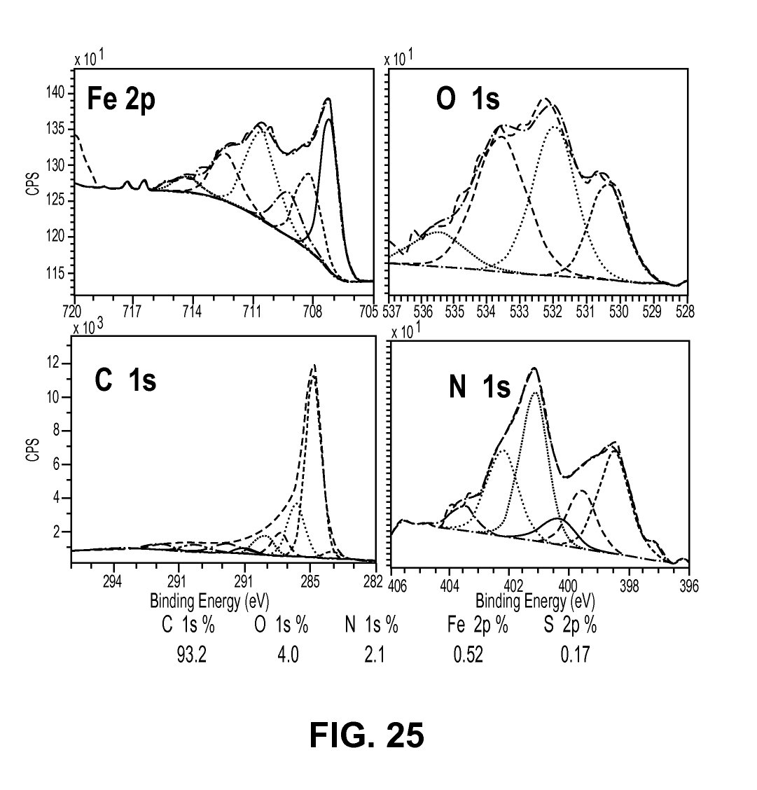

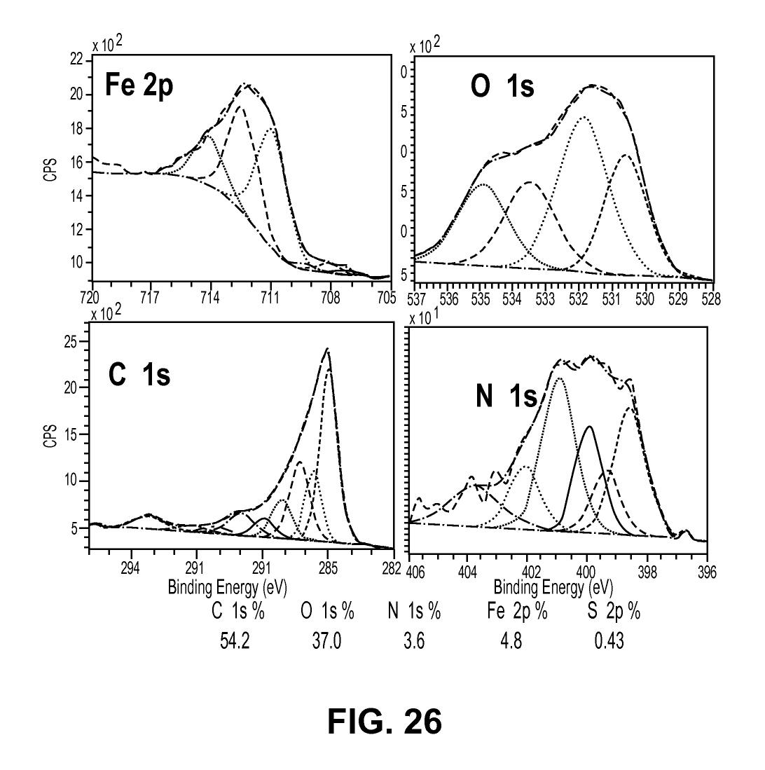

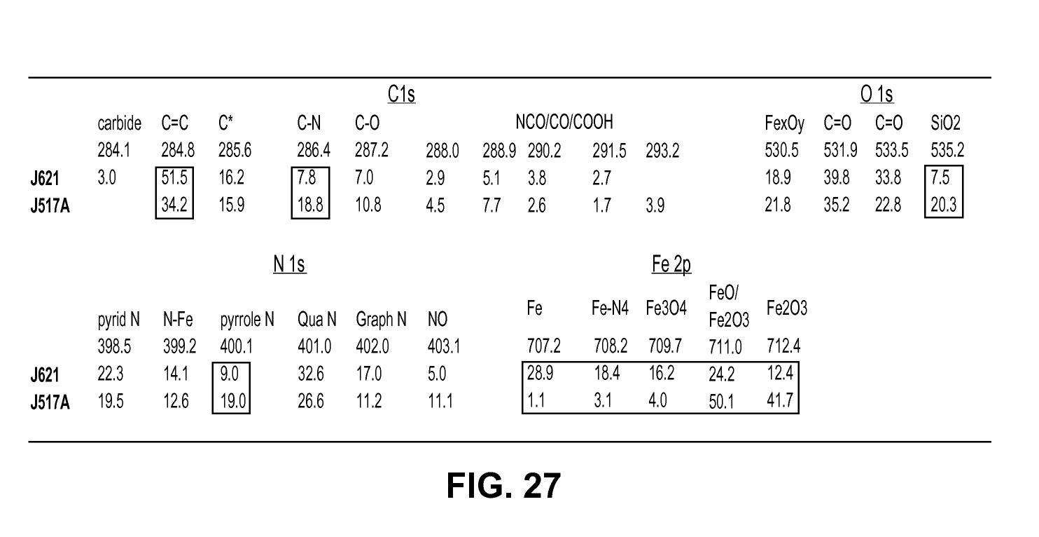

FIGS. 25 and 26 show XPS results for two selected catalysts J621 (FIG. 25) and J517A (FIG. 26). Although these two catalysts were comprised of the same starting precursors, they yield very different XPS results. FIG. 27 is a table showing the results from analysis of species found in sample J621 and J517A, corresponding to FIGS. 25 and 26. The shaded boxes highlight the primary differences between the two samples. Specifically, the primary differences are seen in the total carbon, oxygen and iron content. J517A creates a catalyst that is heavily weighted with oxygen on the surface. This could be one explanation as to why the performance of this material was insufficient. Another important difference is the weighting of the metal species. For every iron species found, the differences were statistically significant between the two samples. For instance, sample 517A forms almost entirely iron-oxide complexes, versus the elemental and nitrogen bound iron formed in the J621 sample. We assume the lack of iron-oxide species in sample J621 is due to the 12-hour H₂SO₄ treatment this sample underwent. Finally, another distinct difference is the amount of pyrrolic nitrogen. J517A contains significantly more, perhaps owing to its low electrochemical performance. These results are from averages of 3 regions scanned for each sample. FIG. 27 is a table showing the results from analysis of species found in sample J621 and J517A, corresponding to FIGS. 25 and 26. The shaded boxes highlight the primary differences between the two samples.

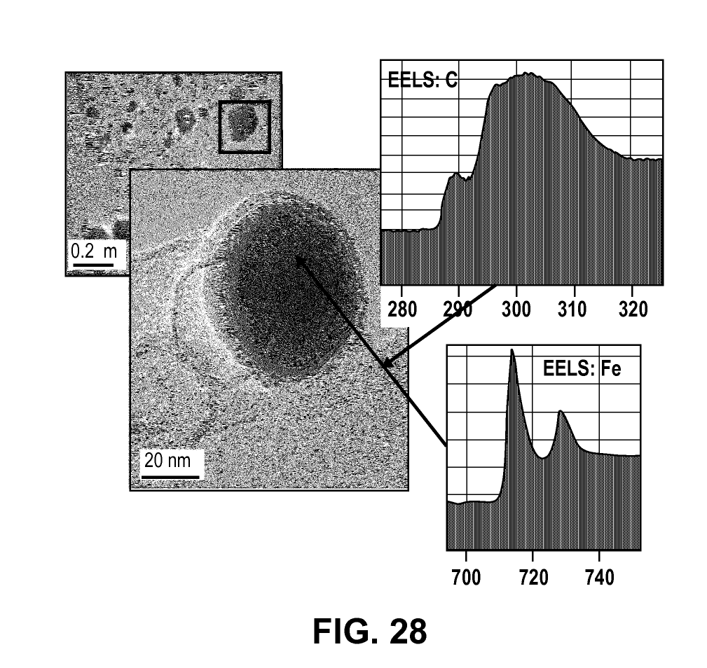

EELS spectra are shown in FIG. 28 for sample J621. The higher resolution TEM image is focused on an iron particle trapped inside the carbon matrix. Here we find the carbon backbone is partially graphitic and partially amorphous, but tending more towards graphitic from analysis of the σ* to π* peaks.

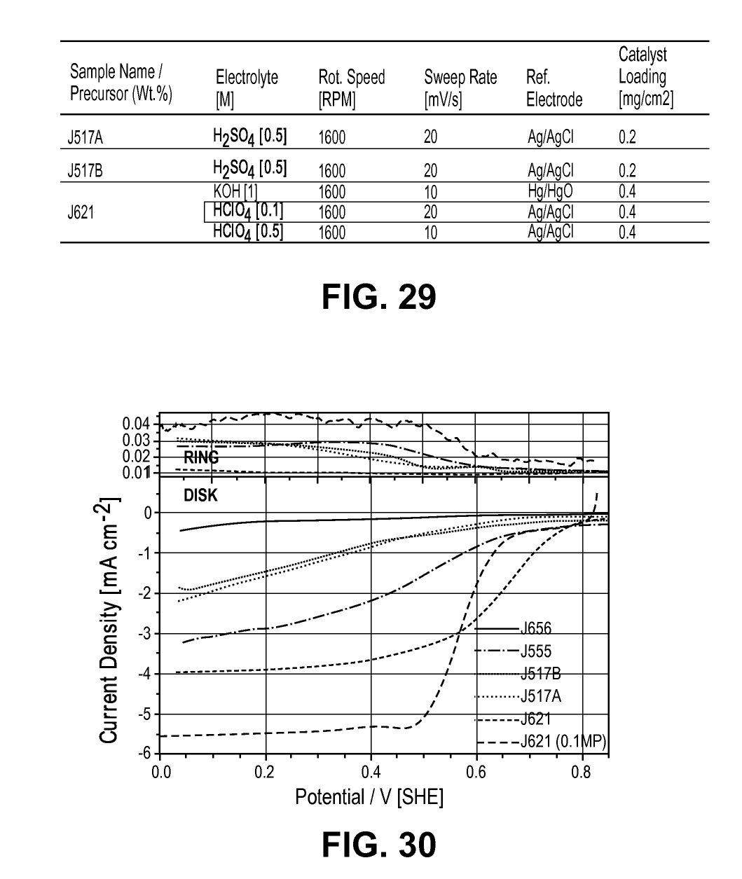

RRDE measurements were performed for all samples prepared for this project. FIG. 29 is a summary table of the experimental conditions. FIG. 30 summarizes the results for catalysts tested in acidic media. The RRDE data for the samples presented here (J517A/B and J621) are in blue, green, aquamarine, and red. There are two additional samples in the figure that were tested and analyzed at the same time, but are not relevant to this paper. These results are the average of 10 sweeps, after a series of 20 scans at 100 mV/s to remove surface metals. All samples except J621, which was in one case also evaluated in 0.1M HClO₄ (red), were tested in 0.5M H₂SO₄. Also shown for these samples is the peroxide formation, collected by the ring of the electrode. This peroxide production is considered negligible.

Although samples J517A/B are only slightly catalytically active, sample J621 clearly demonstrates a non-PGM catalyst for ORR. This is likely due to the H2SO4 post treatment this sample underwent which presumably removed many of the metal oxide species.

1. A method for forming a self-supported non-platinum group metal catalyst comprising:
combining a population of sacrificial hierarchically structured particles with a transition metal salt and a Nitrogen-Carbon (N—C) precursor;
pyrolyzing the combination; and
removing the sacrificial particles to produce a self-supported non-platinum group metal catalyst.

2. The method of claim 1 wherein the sacrificial particles are formed from silica.

3. The method of claim 2 wherein the method of removing the sacrificial particles comprises acid etching.

4. The method of claim 1 wherein the sacrificial hierarchically structured particles are combined with a salcomine or salcomine-like precursor.

5. The method of claim 1 wherein the sacrificial hierarchically structured particles are combined with a non-salcomine-like precursor.

6. The method of claim 1 further comprising pyrolyzing the self-supported non-platinum group metal catalyst.

7. (canceled)

8. The method of claim 1 further comprising synthesizing the hierarchically structured particles and combining them in a single synthesis step.

9. A self-supported non-platinum group metal catalyst having the three-dimensional structure that is the inverse of the three-dimensional structure of a population of particles having a hierarchical pore structure.

10. The catalyst of claim 9 formed by:
combining a population of sacrificial hierarchically structured particles with a transition metal salt and a Nitrogen-Carbon (N—C) precursor;
pyrolyzing the combination; and
removing the sacrificial particles to produce a self-supported non-platinum group metal catalyst.

11. The catalyst of claim 9 formed by:
combining a sacrificial support precursor with a transition metal salt and a Nitrogen-Carbon (N—C) precursor under suitable conditions to form a population of particles having a hierarchical pore structure infused with the transition metal salt and N—C precursor;
pyrolyzing the combination; and
removing the sacrificial support to produce a catalyst having the inverse morphological features of the particles.

12. The catalyst of claim 10 wherein the N—C precursor is a salcomine precursor.

13. The catalyst of claim 10 further comprising re-pyrolyzing the catalyst after removal of the sacrificial support.

14. A method comprising:
combining a sacrificial support precursor with a transition metal salt and a Nitrogen-Carbon (N—C) precursor under suitable conditions to form a population of particles having a hierarchical pore structure infused with the transition metal salt and N—C precursor;
pyrolyzing the infused particles; and
removing the sacrificial support to produce a catalyst having the inverse morphological features of the particles.

15. The method of claim 14 wherein the sacrificial support precursor is a silica precursor.

16. The method of claim 14 wherein the N—C precursors are salcomine or salcomine-like precursors.

17. The method of claim 14 wherein the N—C precursors are non-salcomine precursors.

18. The method of claim 14 further comprising re-pyrolyzing the catalyst after the sacrificial support is removed.

19. The method of claim 14 wherein the N—C precursors are selected from the group consisting of: Polyethyleneamine; ethylenediamine branched; 4-Aminoantipyrine; 1,2-Phenyanthroline; Phenanthroline; Poly(2-ethyl-2-oxazoline); Poly(4-vinylpyridine); Poly(acrylamide-co-diallyldimethylammonium chloride) solution; Poly(melamine-co-formaldehyde) methylated, solution; Poly(pyromellitic dianhydride-co-4,4?-oxydianiline), amic acid solution; Poly(dimethylamine-co-epichlorohydrin-co-ethylenediamine) solution; Poly(1-vinylpyrrolidone-co-2-dimethylaminoethyl methacrylate) solution; Poly(1-vinylpyrrolidone-co-2-dimethylaminoethyl methacrylate) solution; Poly[[6-[(1,1,3,3-tetramethylbutyl)amino]-s-triazine-2,4-diyl]-[(2,2,6,6-tetramethyl-4-piperidyl)imino]-hexamethylene-[(2,2,6,6-tetramethyl-4-piperidyl)imino]; 4-(Aminomethyl)pyridine; 2-Amino-4-picoline; Aminophylline; 2-Amino-6-methylpyridine 98%; 2-Amino-3-picoline; piperazine; Pyrimidyl; imidazole; indole; pyrazole; piperidine; Pyrrolidinyl; pyrrolidine; 4,4?-Oxydianiline;) 1-(2-Aminoethyl)piperazine; Aminophylline; 1,2,4-Triazole; 3,5-Diamino-1,2,4-triazole; Phenazinemelamine; and urea.

20-25. (canceled)

26. The method of claim 1 wherein the N—C precursors are selected from the group consisting of: Polyethyleneamine; ethylenediamine branched; 4-Aminoantipyrine; 1,2-Phenyanthroline; Phenanthroline; Poly(2-ethyl-2-oxazoline); Poly(4-vinylpyridine); Poly(acrylamide-co-diallyldimethylammonium chloride) solution; Poly(melamine-co-formaldehyde) methylated, solution; Poly(pyromellitic dianhydride-co-4,4?-oxydianiline), amic acid solution; Poly(dimethylamine-co-epichlorohydrin-co-ethylenediamine) solution; Poly(1-vinylpyrrolidone-co-2-dimethylaminoethyl methacrylate) solution; Poly(1-vinylpyrrolidone-co-2-dimethylaminoethyl methacrylate) solution; Poly[[6-[(1,1,3,3-tetramethylbutyl)amino]-s-triazine-2,4-diyl]-[(2,2,6,6-tetramethyl-4-piperidyl)imino]-hexamethylene-[(2,2,6,6-tetramethyl-4-piperidyl)imino]; 4-(Aminomethyl)pyridine; 2-Amino-4-picoline; Aminophylline; 2-Amino-6-methylpyridine 98%; 2-Amino-3-picoline; piperazine; Pyrimidyl; imidazole; indole; pyrazole; piperidine; Pyrrolidinyl; pyrrolidine; 4,4?-Oxydianiline;)1-(2-Aminoethyl)piperazine; Aminophylline; 1,2,4-Triazole; 3,5-Diamino-1,2,4-triazole; Phenazinemelamine; and urea.

27. The catalyst of claim 11 wherein the N—C precursor is a salcomine precursor.
